(19) United States
(12) Patent Application Publication
(10) Pub. No.: US 2007/0243457 A1
(43) Pub. Date: Oct. 18, 2007

(54) ELECTRONIC DEVICE WITH MULTIPLE BATTERY CONTACTS

(76) Inventors: Andres Viduya, Cranberry Township, PA (US); Ryan Anthony Zoschg, Oakmont, PA (US)

Correspondence Address: WOOD, HERRON & EVANS, LLP, 2700 CAREW TOWER, 441 VINE STREET, CINCINNATI, OH, 45202, US

(21) Appl. No.: 11/279,412

(22) Filed: Apr. 12, 2006

(51) Int. Cl. H01M 2/10

(52) U.S. Cl. 429/96; 429/97

(57) ABSTRACT

An electronic device comprises a housing having a cavity configured to removably receive a battery. A first electrical contact associated with the housing is adapted to be electrically coupled to the battery in a first contact plane and a second electrical contact is adapted to be electrically coupled to the battery in a second contact plane. The second contact plane is angled relative to the first contact plane such that the device is adapted to be electrically coupled to the battery along more than one axis or plane.

### FIELD OF THE INVENTION

This invention relates generally to batteries, and more specifically, to batteries used in mobile devices, such as mobile computer terminals,

### BACKGROUND OF THE INVENTION

Wearable, portable, and/or mobile devices are used in many industries to complete a wide variety of tasks. Such devices, which are often in the form of portable computer terminals, are carried or worn by a worker or user as they move around performing various tasks. The terminals typically provide workers with increased mobility while collecting and storing data and/or communicating with a larger, centralized computer system. In one example, the mobile terminals receive commands from and send information to the centralized computer system so that certain tasks are effectively monitored and completed efficiently and the proper data is collected. In other examples, the terminals are stand-alone devices that collect data.

One field where wearable or portable terminals have proven to be particularly advantageous is in voice applications where work is performed using voice commands and responses, such as in inventory management. Computerized voice-driven systems are used to complete various tasks essential to certain industries, such as product distribution and quality control in an inventory management system. An overall voice system generally involves a combination of a central computer system for tracking and management and the people who use and interface with the central computer system, such as order-fillers, pickers, and other workers who wear or carry the mobile terminals. The workers handle the manual aspects of these integrated systems.

To this end, wearable or portable devices and terminals enable the workers to collect data and interface with a central computer system as they complete their numerous tasks. The wearable terminals may, for example, pull information directly from the central computer system and translate the information into voice or text commands for the workers. Through wireless RF networks, the commands to and responses from the workers are communicated between the system and the terminals. Oftentimes, for voice applications, the workers wear a headset that enables them to receive voice instructions, ask questions, report the progress of their tasks, and report working conditions. The terminals therefore enable the workers to complete their tasks in a “hands-free” manner without bulky equipment to juggle or paperwork to carry around.

One example of a portable terminal being used in this manner is in a warehouse environment. Once activated by a worker, the terminal welcomes the worker to the system and defines an order or load to be filled for a certain truck departing from the warehouse. After the worker indicates the particular area he or she will be working in for that order, the terminal directs him or her to a particular aisle and bin to pick up a specific quantity of an item. The worker then follows these directions and sends a verbal confirmation once complete. In that way, orders are filled.

Although portable terminals provide workers with increased mobility, there are several challenges associated with powering these devices. In particular, the terminals are typically powered by a portable power source, such as a battery. The terminals sometimes fail to maintain an electrical connection with the battery because the devices are often subject to rigorous use as the workers move and scramble around handling various tasks. For example, warehouse workers are often moving rapidly around their work area and jumping on and off equipment and the like. During these movements the terminals may be bumped or impacted, or may actually be dropped or detached from the worker and fall to the ground. The resulting forces experienced by the terminals can cause the battery contacts to “bounce” and separate from the battery for small fractions of time.

The failure to maintain an electrical connection, even for only a couple of milliseconds, can lead to significant down time and a reduction in overall efficiency. It can also lead to lost data or interrupted communications. In particular, once the terminal loses its electrical connection, it must typically reboot to reestablish proper communication with the central computer system. Workers are prevented from performing their tasks and may be left standing around awaiting further instruction from the central computer system. This leads to inefficiency and a loss of productivity.

Therefore, it is desirable to improve upon the battery contacts in mobile electronic devices. It is specifically desirable to provide such improvements for devices used in an environment where they are accidentally dropped or impacted.

### SUMMARY OF THE INVENTION

The present invention provides an electronic device that requires an electrical connection with a battery or battery pack. The device generally comprises a housing having an interior for housing electronics and external cavity configured to removably receive the battery. Once installed, the battery is electrically coupled to the electronics by first and second electrical contacts associated with the housing. The first electrical contact is electrically coupled to the battery in a first contact plane, while the second electrical contact is electrically coupled to the battery in a second contact plane. Because the first contact plane is angled relative to the second contact plane, the electronic device is protected from disconnect with the battery in multiple directions.

The first and second electrical contacts may be advantageously arranged in a parallel circuit. Accordingly, if one of the electrical contacts loses its connection with the battery, the device will continue to be powered by the battery due to the electrical connection maintained by the other electrical contact. The device may also include a plurality of the first and second electrical contacts to further promote electrical coupling with the battery. The plurality of first and second electrical contacts may be adapted to contact a single battery terminal or a corresponding plurality of battery terminals.

Thus, in summary, the electronic device is particularly suited for environments where it may be accidentally dropped or otherwise subjected to impact forces. For example, the electronic device may be a portable or mobile computer terminal worn by a worker in a warehouse. As the worker moves about the warehouse and uses the terminal to communicate with a larger, centralized computer system, the first and second battery contacts help keep the device powered and eliminate the loss of time associated with rebooting the terminal.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is a perspective view of an electronic device according to one embodiment of the invention;

FIG. 2 is a perspective view of a battery pack adapted to be removably received in the device of FIG. 1;

FIG. 3 is a side view, partially in cross-section, of the electronic device of FIG. 1;

FIG. 4 is an enlarged view similar to FIG. 3 showing a portion of the electronic device with the battery pack removed; and

FIG. 5 is a schematic view showing how the battery pack of FIG. 2 is coupled to electronics in the device of FIG. 1.

### DETAILED DESCRIPTION

Although the invention will be described below in relation to certain embodiments, the invention is not limited to practice in any one specific type of portable or wearable electronic device. It is contemplated that the principles of the invention can be used with a variety of electronic devices, including but not limited to wearable, portable, and/or mobile computer terminals. The description of the invention is intended to cover all alternatives, modifications, and equivalent arrangements as may be included within the spirit and scope of the invention as defined by the appended claims. In particular, those skilled in the art will recognize that the components of the invention described herein could be arranged in multiple different ways.

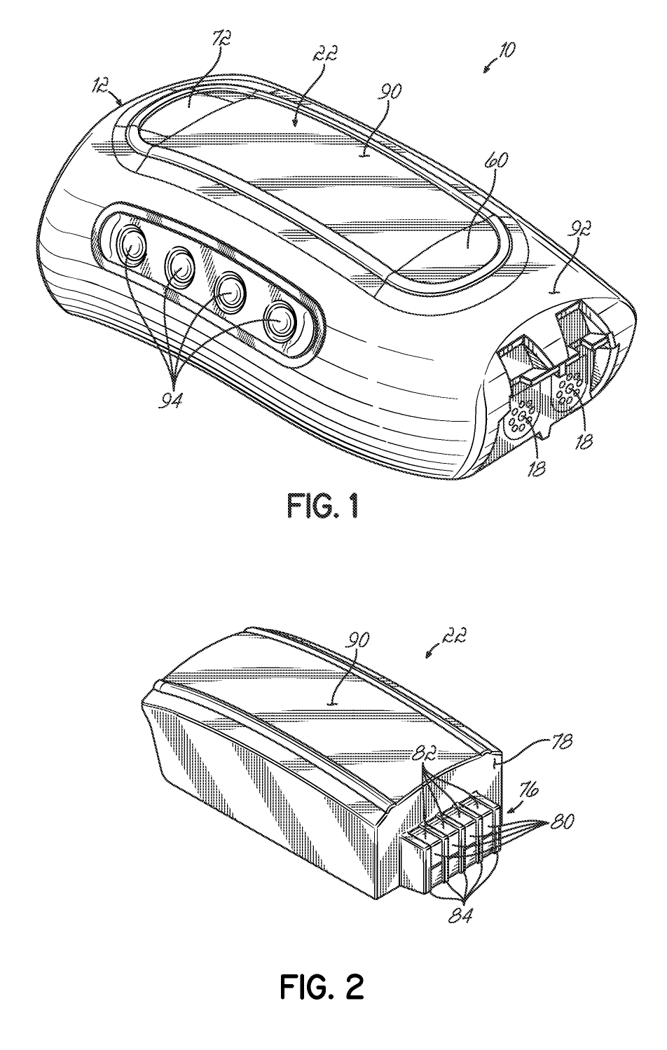

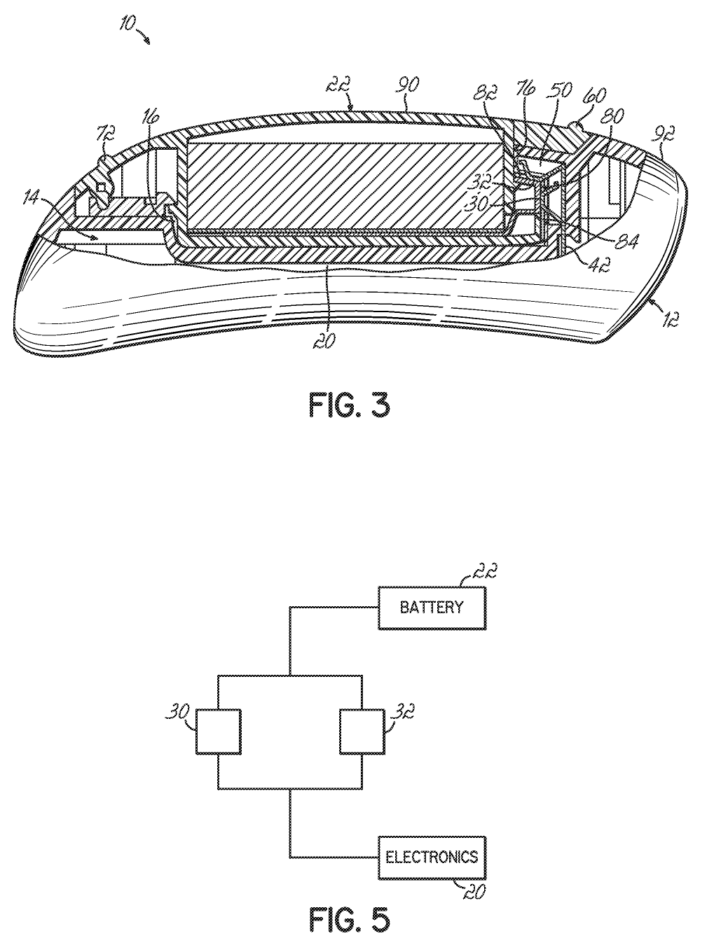

FIGS. 1 and 3 show one embodiment of an electronic device 10 according to the invention. More specifically, FIGS. 1 and 3 show a portable or mobile terminal 10 designed to be worn by a worker, such as for tasks using voice applications. The terminal 10 generally comprises a housing 12 having an interior 14 and external cavity 16. The housing may be made of a suitable material, such as plastic. The terminal 10 may include ports 18 for at least one peripheral device, such as a headset or bar-code reader (not shown), that is typically coupled to the interior electronics 20 through the ports 18. The interior 14 houses electronics 20 which may include a processor and a transceiver (not shown) for communicating with a remote central computer. The electronics 20 are powered by a power source, such as a battery or battery pack 22 removably received in the external cavity 16, as will be described in greater detail below.

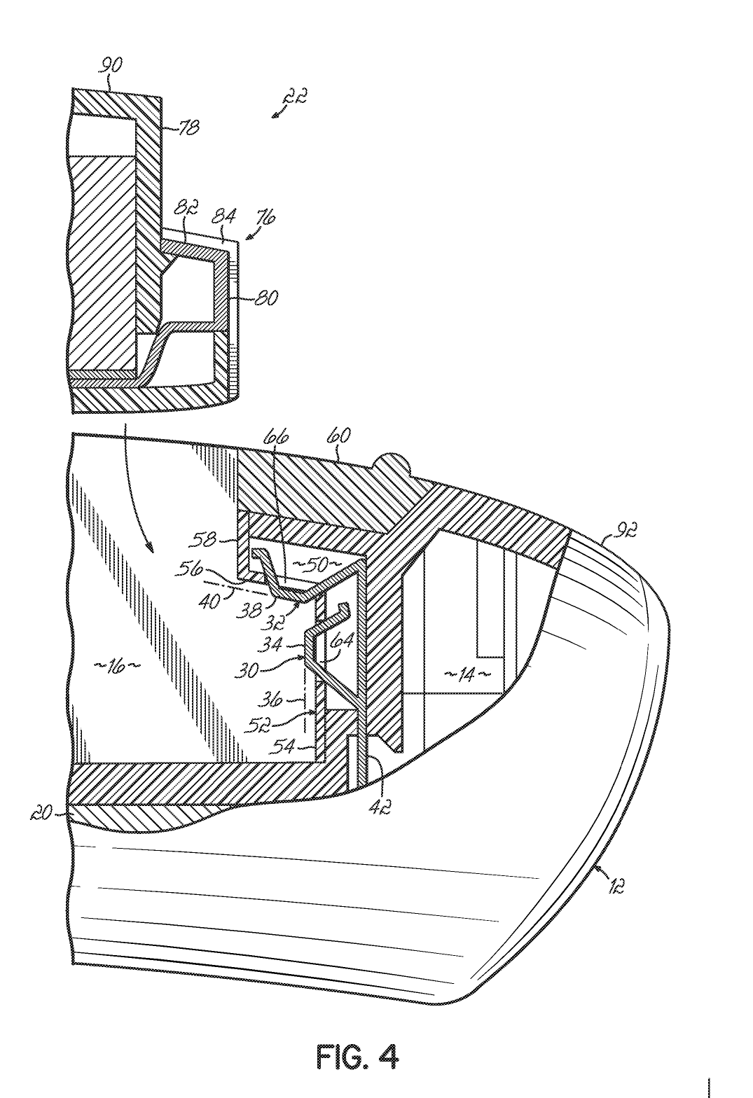

With reference to FIGS. 3 and 4, the housing 12 further includes first and second electrical contacts 30, 32 extending into the external cavity 16. The first electrical contact 30 includes a contact face or portion 34 adapted to be electrically coupled to the battery 22 in a first contact plane 36. The second electrical contact 32 includes a contact face or portion 38 adapted to be electrically coupled to the battery 22 in a second contact plane 40. In accordance with one aspect of the invention, the first and second contact planes 36, 40 are angled relative to each other. The construction and shape of contacts 30, 32 and their orientation, along with the terminals of battery 22, provide the desired angled orientation of planes 36, 40. Thus, although the electrical contacts 30, 32 are shown as spring arms having triangular or trapezoidal profiles, those skilled in the art will appreciate other contact designs and shapes may be used to achieve a similar arrangement. For example, the first and second contacts 30, 32 may be helical in nature with one end representing the respective contact portions 34, 38. In the illustrated embodiment, a common tang member or base 42 anchors both of the contacts 30, 32 to the housing 12 and electrically couples the contacts to the electronics 20. The construction of the contacts 30, 32 and surrounding structures provides their spring-loaded feature when the battery 22 is inserted into cavity 16.

In one embodiment, the first and second electrical contacts 30, 32 are located within a chamber 50 positioned proximate to the external cavity 16. The chamber 50 is separated from the external cavity 16 by an end wall 52 having a stepped, or offset, profile. In other words, the end wall 52 includes a first section 54 generally proximate to the first contact plane 36, a second section 56 generally proximate the second contact plane 40 (and therefore angled relative to the first section 54), and a third section 58 extending from the second section 56 to a cover or component 60 that helps secure the battery pack 22 in the external cavity 16. A first opening 64 is located in the first section 54 so that the contact portion 34 of the first electrical contact 30 can extend through the end wall 52 and into the external cavity 16. Likewise, a second opening 66 is located in the second section 56 so that the contact portion 38 of the second electrical contact 32 can extend into the external cavity 16 as well.

FIGS. 3 and 4 only shows one set of electrical contacts in cross-section. The particular embodiment shown in the figures, however, includes a plurality of the first and second electrical contacts 30, 32 spaced across the width of the external cavity 16 to interface with multiple terminals of battery 22. Accordingly, a corresponding plurality of the first and second openings 64, 66 are provided in the end wall 52 to allow the respective contact portions 34, 38 associated with the plurality of first and second electrical contacts 30, 32 to extend into the external cavity 16.

As shown in FIGS. 1-3, the external cavity 16 is configured to removably receive the battery or battery pack 22. More specifically, the external cavity 16 is shaped to cooperate with the battery 22 and the housing 12 further includes a latch mechanism 72 for detachably securing the battery pack 22 therein. The battery pack 22 supplies electrical power to the electronics 20 so that the terminal 10 can be worn by a worker and moved about with ease. As a worker uses the terminal 10, the electrical energy stored by the battery 22 is depleted until the battery's capacity is expended. The worker can then restore capacity of the battery by charging a rechargeable battery 22 with a battery charger (not shown) that provides a DC current or may replace the battery 22 with another battery.

Now referring to FIGS. 2 and 3, the battery 22 of the invention includes one or more battery terminals 76 spaced along an end surface 78. The battery terminals 76 project outwardly from the end surface 78 and each include a first contact surface or face 80 opposite the end surface 78 and a second contact surface or face 82 extending between the end surface 78 and first surface 80. In the embodiment shown in the figures, the battery terminals 76 are each bordered by dividing walls 84 and therefore spaced apart from each other. However, the battery 22 may alternatively include one long, continuous terminal (not shown) extending across a portion of the end surface 78. The terminal surfaces 80, 82 are angled relative to each other in different planes to coincide with the contacts 30, 32.

The battery pack 22 is installed in the housing 12 by manually inserting it into the external cavity 16. The projection supporting the terminals 76 fits into the cavity portion housing contacts 30, 32. Eventually the latch mechanism 72 secures the battery 22 into the appropriate position, with a top surface 90 of the battery 22 being substantially flush with an exterior surface 92 of the housing 12 and the battery terminals 76 being generally aligned with the end wall. The first and second surfaces 80, 82 of the battery terminals 76 are positioned substantially proximate to or are shaped or adapted to abut against the first and second sections 54, 56 of the end wall 52. As a result, the first and second surfaces 80, 82 contact the respective contact portions 34, 38 of the first and second electrical contacts 30, 32 and push against the contacts. The electrical contacts 30, 32 slightly deflect within the chamber 50 to accommodate this interaction and thereby apply a slight spring load to the battery pack 22.

The contact between the battery terminals 76 and the contact 30, 32 establishes an electrical connection between the battery pack 22 and electronics 20. Thus, once the battery pack 22 is appropriately positioned, a worker can activate the terminal 10 and begin its operation. The worker can then interact with the terminal by inputting data, such as through voice commands or other methods, receiving outputs, such as by voice commands or other methods, and by pressing control buttons 94 (FIG. 1) located on the exterior surface 92 of the terminal 10. As may be appreciated, the invention is not limited to the specific operational parameters of terminal 10.

As the worker moves about and completes tasks or receives instructions, such as from a central computer system, the mobile terminal 10 may be accidentally dropped or impacted by nearby equipment or machinery. If the resulting forces cause one of the electrical contacts to “bounce” and become separated from the battery terminal 76, the other electrical contact will help maintain an electrical connection. The positioning of the contacts in angled planes provides contact in one plane when the other plane may lose contact. For example, a force on terminal 10 (i.e., a drop or impact) will generally be predominantly in one plane. As such, while the contact might bounce in one plane, the contact in the other plane will still maintain a solid connection. The contacts 30, 32 are electrically coupled in parallel so that failure or a disconnect of one contact will not interrupt power delivery to the terminal electronics 20. For example, FIG. 5 schematically illustrates how the first and second electrical contacts are arranged in a parallel circuit. Thus, if the first electrical contact 30 fails to remain electrically coupled to the battery 22, the electronics 20 will continue to receive power from the battery 22 through the second electrical contact 32. The same feature applies if the second electrical contact 32 becomes separated from the battery 22 and the first electrical contact 30 maintains its connection. In that way, the present invention prevents power interruption due to impact forces on the terminal that occur during its typical use.

In summary, the multiple-contact design of the terminal 10 helps prevent disconnect with the battery 22 in multiple axes or directions. Thus, in the example, if the contact planes 36, 40 are substantially perpendicular to each other, the terminal may be prevented from being disconnected in an x-axis and y-axis. It will be appreciated that the present invention is not limited to only two contacts or sets of contacts in two planes. Rather, a greater number of contacts and respective planes might be utilized. Furthermore, the invention is not limited to planes that are substantially perpendicular as illustrated. Rather, the planes might be at other angles to ensure continuous contact. Such a design is likely to reduce the number of times that the terminal 10 loses power for small fractions of time. Rather than sitting around waiting for the terminal to reboot and reestablish proper communication with the centralized computer system, a worker can continue to perform his or her tasks without interruption or down time and thus increase efficiency and productivity.

While the invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicants' general inventive concept.

What is claimed is:

1. An electronic device powered by a battery, comprising:
a housing having a cavity configured to removably receive the battery, a first electrical contact adapted to be electrically coupled to the battery in a first contact plane, and a second electrical contact adapted to be electrically coupled to the battery in a second contact plane, said second contact plane being angled relative to said first contact plane.

2. The electronic device of claim 1, wherein said second contact plane is substantially perpendicular to said first contact plane.

3. The electronic device of claim 1, wherein said housing further comprises a chamber positioned proximate to said cavity and an end wall separating said chamber from said cavity, said end wall having a first opening proximate said first contact plane and a second opening proximate said second contact plane, said first electrical contact being positioned within said chamber and having a contact portion extending through said first opening, and second electrical contact being positioned within said chamber and having a contact portion extending through said second opening.

4. The electronic device of claim 1, further comprising a plurality of said first and second electrical contacts.

5. The electronic device of claim 1, wherein said first and second electrical contacts are arranged electrically in parallel.

6. The electronic device of claim 1, wherein said first and second electrical contacts are spring-loaded so as to apply a force to the battery when the battery is received in said cavity.

7. The electronic device of claim 6, wherein said first and second electrical contacts are spring members coupled to a tang member.

8. An electronic device, comprising:
a battery having a plurality of battery terminals; and
a housing having a cavity configured to removably receive said battery, a plurality of first electrical contacts adapted to be electrically coupled to said plurality of battery terminals in a first contact plane, and a plurality of second electrical contacts adapted to be electrically coupled to said plurality of battery terminals in a second contact plane, said second contact plane being angled relative to said first contact plane.

9. The electronic device of claim 8, wherein said second contact plane is substantially perpendicular to said first contact plane.

10. The electronic device of claim 8, wherein said housing further comprises a chamber positioned proximate to said cavity and an end wall separating said chamber from said cavity, said end wall having a plurality of first openings proximate to said first contact plane and a plurality of second openings proximate to said second contact plane, said plurality of first and second electrical contacts being positioned within said chamber and respectively extending through said plurality of first and second openings in said end wall for electrically coupling to said battery.

11. The electronic device of claim 8, wherein said plurality of first and second electrical contacts are arranged electrically in parallel.

12. The electronic device of claim 8, wherein said plurality of first and second electrical contacts are spring-loaded so as to apply a force against said battery when said battery is received in said cavity.

13. The electronic device of claim 12, wherein said plurality of first and second electrical contacts each comprise a spring member coupled to a tang member.

14. A method of powering an electronic device, comprising:
inserting a battery in a cavity of a device housing;
contacting a portion of the battery with an electrical contact of the device in a first contact plane; and
contacting a portion of the battery with an electrical contact of the device in a second contact plane, the second contact plane being angled relative to the first contact plane.

15. The method of claim 14, wherein the second contact plane is substantially perpendicular to the first contact plane.

16. The method of claim 14, wherein the first and second electrical contacts are arranged electrically in parallel.

17. A method of powering an electronic device comprising:
contacting terminals of a power source with electrical contacts of the electronic device in multiple contact planes that are angled from each other.

18. A battery having a terminal with a first contact surface in one plane and a second contact surface in another plane at an angle to the one plane.
